(19) United States
(12) Patent Application Publication
(10) Pub. No.: US 2014/0083873 A1
(43) Pub. Date: Mar. 27, 2014

(54) CAPSULES FOR MAKING INFUSED DRINKS

(71) Applicant: CAPITANI S.r.l., Solbiate (IT)

(72) Inventor: Gionata Capitani, Solbiate (IT)

(21) Appl. No.: 13/971,898

(22) Filed: Aug. 21, 2013

(30) Foreign Application Priority Data
Sep. 24, 2012 (EP) 12185726.2

(51) Int. Cl. B65D 85/804; A47J 31/40

(52) U.S. Cl. CPC B65D 85/8046; A47J 31/407
USPC 206/5; 99/295

(57) ABSTRACT

Capsules for making an infused drink which include a tray-like body substantially cylindrical or a truncated cone shape made from a sheet of paper or paper material and open at one end, and a cover or sealing film applied to said open end of the tray-like body are provided. Such capsules may further include a peripheral annular rim suitable for abutting with a support surface which surrounds an infusion chamber of an infusion group when the capsule is inserted in said chamber. The peripheral annular rim may have a greater rigidity than the tray-like body, which can be achieved, for example, by giving said rim a greater thickness than the thickness of the walls which form said tray-like body.

### CROSS-REFERENCE TO RELATED APPLICATION

This application claims priority to and benefit of European Patent Application No. 12185726.2 filed Sep. 24, 2012, the contents of which are incorporated by reference in their entirety.

### FIELD OF THE INVENTION

The present invention relates to capsules containing aromatic substances for making an infused drink, such as coffee, tea, herb teas, fruit juices etc.

### BACKGROUND OF THE INVENTION

Capsules for use with machines for making an infused drink typically include a tray-like body containing an aromatic substance. The body has a peripheral annular rim suitable for abutting with a support surface which surrounds an infusion chamber of an infusion group when the capsule is inserted in said chamber. Normally these capsules are made of plastic material, unlike pods, which are made with a paper filter.

In the attempt to resolve disposal problems associated with plastic capsules, given the huge number of capsules made throughout the world, capsules made from a sheet of paper have been proposed.

However, it has been found that the paper capsules do not provide optimal functioning compared to plastic capsules. For example, in some cases problems with sealing at the moment of closing the infusion chamber have arisen. Applicant has identified the cause of such malfunction in the peripheral annular rim which, made of the same thickness as the initial sheet of paper, proves too fine and soft. Such problem of excessive lightness of the rim is accentuated by the fact that the surface is not perfectly flat and uniform but is slightly undulated due to the production process of the tray-like body.

### SUMMARY OF THE INVENTION

The present invention provides paper capsules which are able to overcome the above-described drawbacks.

Such capsules include those having a tray-like body having a substantially cylindrical or a truncated cone shape said tray-like body being formed by a sheet of paper or paper material which is open at one end, wherein a cover or sealing film is applied to said open end of the tray-like body, said capsule further including a peripheral annular rim suitable for abutting with a support surface which surrounds an infusion chamber of an infusion group when the capsule is inserted in said chamber, wherein at least said peripheral annular rim has a greater rigidity than the tray-like body.

Characteristics and advantages of capsules according to the invention will be evident from the description given below, by way of non-limiting examples of embodiments of the invention described herein and, according to the appended drawings briefly described below.

### BRIEF DESCRIPTION OF THE FIGURES

FIG. 1 is a schematic representation of a capsule according to the invention in a first embodiment;

FIG. 2 is a schematic representation of a capsule in a second embodiment;

FIG. 3 is a view of the separate elements of a capsule in a further embodiment;

FIG. 4 is a schematic representation of a capsule in a further embodiment; and

FIGS. 5A, 5B and 5C are schematic representations of further coupling arrangements between the sealing cover of the capsule to the tray-like body wherein

FIGS. 5B and 5C show details of such coupling.

### DETAILED DESCRIPTION

In the course of the description below, elements of the capsule according to the invention common to the various embodiments described herein will be indicated using the same reference numerals.

In one general embodiment, the capsule for making an infused drink includes a tray-like body 12 substantially cylindrical or a truncated cone shape made from a sheet of paper or paper material and open at one end 14. Said tray-like body 12 therefore includes a base or bottom wall 121, opposite the open end 14, and a side wall 122.

Paper material refers not only to widely used material made from wood or cellulose pulp, but also those made from other fibres such as cotton, linen, hemp as well as more commonly used recycled paper.

The end wall 121 may be made to be integral with the tray-like body 12, or may be attached to the side wall 122. Moreover, said end wall 121 may be completely closed or have holes or be made with a permeable or filter material to permit the entrance of the infusion liquid or the exit of the infused drink for infusion groups without perforating means.

A cover or sealing film 16, also made from paper or paper material, may be attached to said open end 14 of the tray-like body.

The capsule may further provided with a peripheral annular rim 18 suitable for abutting with a support surface which surrounds an infusion chamber of an infusion group when the capsule is inserted in said chamber.

According to certain embodiments, the sheet of paper used to form the tray-like body 12 may be of reduced thickness and/or consistency, such as to give the walls of the tray-like body 12 reduced rigidity and thereby high deformability.

Thanks to such deformability the same capsule also can adapt to infusion chambers which are slightly different from each other and therefore be used in the infusion groups of different manufacturers. Moreover, the tray-like body 12 may be made slightly over-sized, in a radial and/or axial direction, compared to the dimensions of the cavity of an infusion chamber it is to be housed in, so as to undergo a slight compression at the moment of insertion in said chamber. This provides two advantages. First, the capsule can be filled with aromatic substances without pressing as required by plastic capsules, thereby avoiding rupture of the paper walls. Second, the slight compression exerted by the walls which define the infusion chamber not only makes it possible to offset the reduced pressing of the aromatic substance, but also allows a compacting of aromatic substances contained in the capsule better than that which can be achieved with a plastic capsule. As is known, the more compact the aroma substance inside the capsule, the better the result of the infusion.

For example, the over-sizing of the body of the capsule in relation to the dimensions of the infusion chamber may be realised by forming the side wall of the capsule body and/or the end wall so that they are curved, that is to say, convex.

According to embodiments of the invention, the annular rim 18 has a greater rigidity than the tray-like body 12. This way, it is possible to combine the properties of the tray-like body 12 (e.g. being able to deform to achieve the advantages spoken of above) with a resistance of the annular peripheral rim 18 to the pressure exerted by the infusion group at the moment of closing the infusion chamber.

According to certain embodiments, said greater rigidity of the peripheral annular rim 18 is achieved by forming said rim 18 with a greater thickness than the thickness of the walls which define the tray-like body 12.

In certain embodiments, the peripheral annular rim 18 includes at least one layer in a material having a greater rigidity than that of the tray-like body 12.

In further embodiments, the greater rigidity of the peripheral annular rim 18 is provided by a particular conformation and/or processing of said peripheral annular rim 18.

In certain embodiments, said peripheral annular rim 18 includes at least one annular portion 181 of the sheet of paper formed integrally with the tray-like body 12.

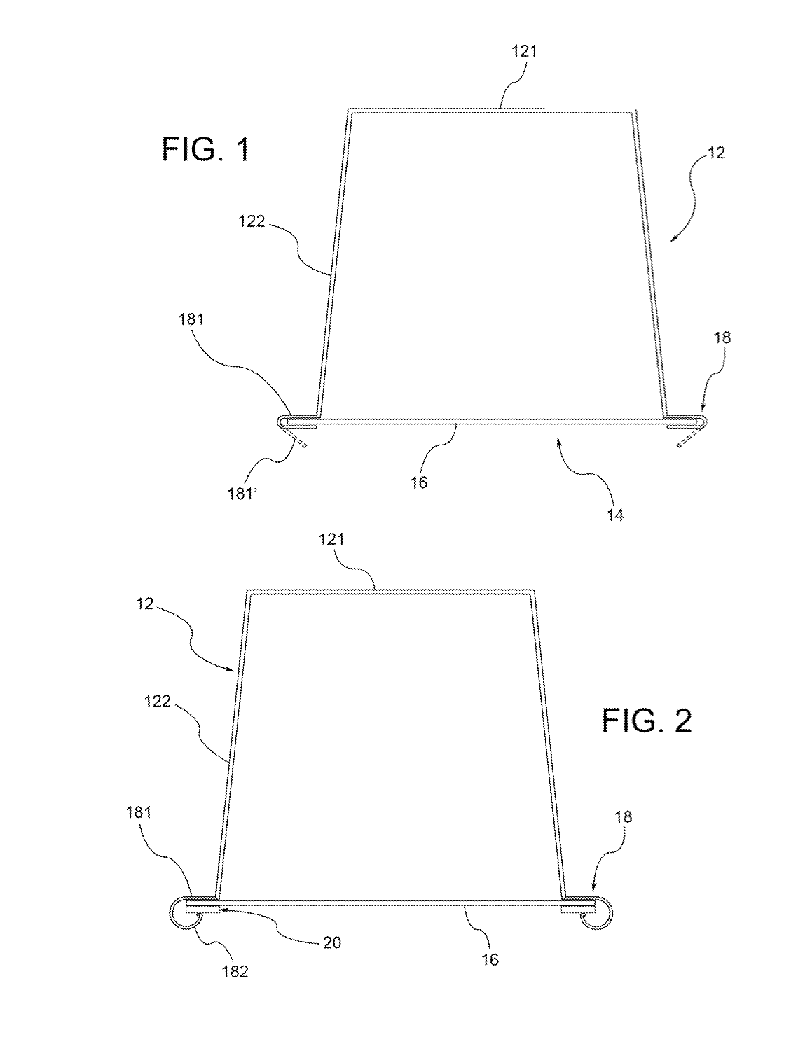

In certain embodiments, such as that shown in FIG. 1, the greater thickness of the peripheral annular rim 18 is obtained by folding the sheet of paper forming the walls of the tray-like body 12 back on itself at least once. In other words, the annular portion 181 of the sheet of paper suitable for forming the peripheral annular rim 18 is made with a breadth substantially double that of the pre-defined radial extension of the annular rim 18, so that, during the realisation of the tray-like body 12, it is possible to fold said annular portion 181 onto itself to achieve the predefined breadth and approximately double the thickness of the initial sheet of paper. The folded portion 181′ of the sheet of paper can be folded forward, that is on the side opposite the side supporting the surface defining the infusion chamber, as shown in FIG. 1, or backwards, toward said surface defining the infusion chamber.

Moreover, as shown in FIG. 1, the cover or sealing film 16 may be inserted between the folded portions of the peripheral annular rim 18. Advantageously, therefore, in this case said rim 18 also may act as a blocking element of the cover or sealing film.

Alternatively, the cover or sealing film 16 may be applied over the folded rim.

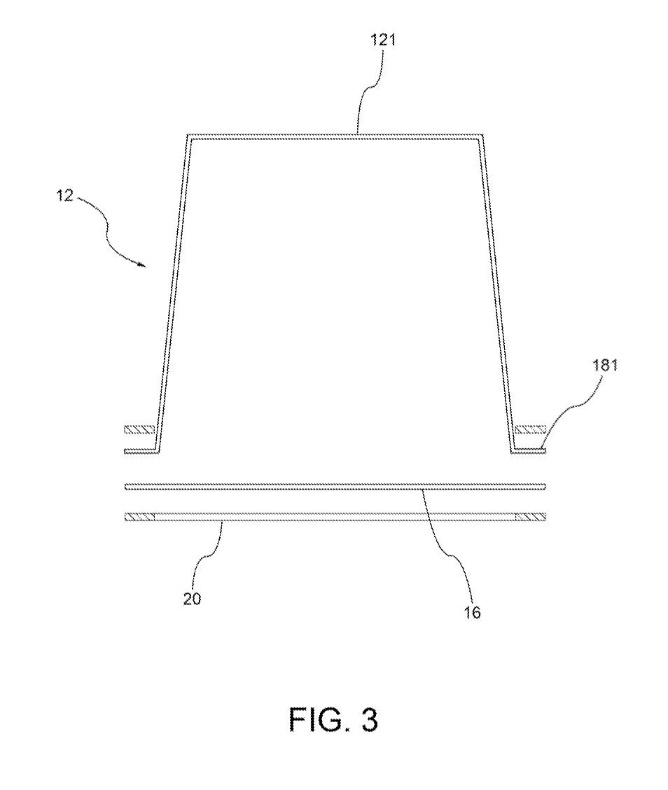

In certain embodiments such as those shown in FIGS. 2 and 3, the peripheral annular rim 18 may include at least reinforcement ring 20 attached to the annular portion 181 of the sheet of paper which surrounds the open end 14 of the tray-like body 12.

In this case too, said reinforcement ring 20 may be applied to the front side of said annular portion 181 of the sheet of paper or on the rear side, or on both sides, as shown in FIG. 3.

In certain embodiments, the cover or sealing film 16 of the tray-like body may be placed between the annular portion 181 of the sheet of paper and the reinforcement ring 20. Advantageously, therefore, the reinforcement ring also may perform the function of attaching the cover or sealing film 16 to the tray-like body.

In certain embodiments such as that shown in FIG. 3, the reinforcement ring is welded or glued to the annular portion of the sheet of paper 181 or to the cover or sealing film.

In certain embodiments such as that shown in FIG. 2, the reinforcement ring 20 is retained on the annular portion 181 of the sheet of paper by a C-shaped extension 182 of said annular portion 181, such as a curled fold, on the reinforcement ring 20, or of a curled fold of the reinforcement ring 20 behind the annular portion 181.

The reinforcement ring 20 may be made from paper and/or other material including at least one resin or gum. In any case, the material of the reinforcement ring 20, like that of the tray-like body 12 and of the cover or sealing film 16, is a food-grade material.

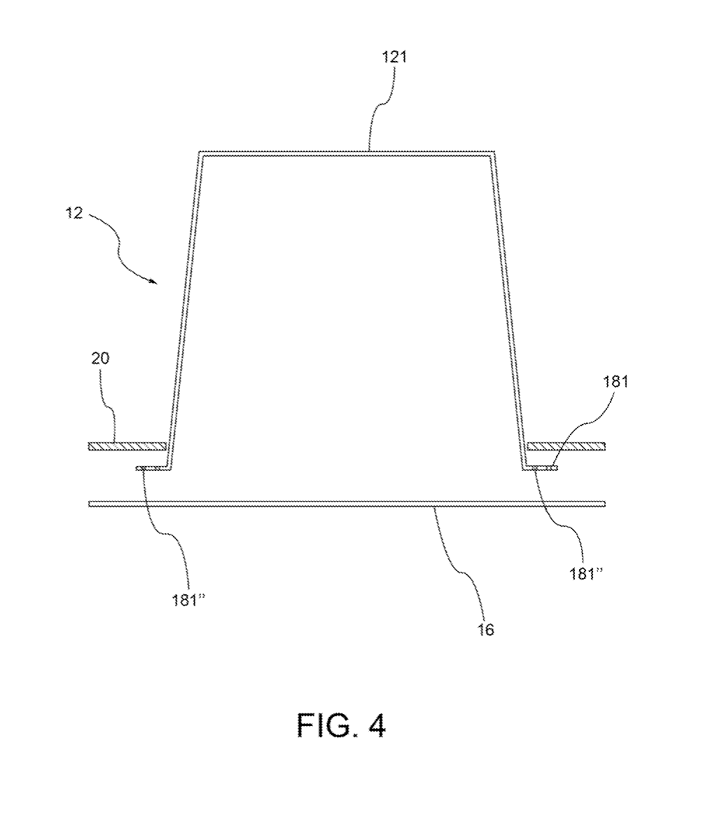

In certain embodiments such as that shown in FIG. 4, the reinforcement ring 20 is attached to the rear side of the annular portion 181 of the sheet of paper and is attached to the cover 16 in such a way that said annular portion 181 of the sheet of paper is retained between the reinforcement ring 20 and the cover 16. In other words, when the reinforcement ring 20 is coupled to the cover 16 the annular portion 181 remains pinched, that is wedged, between the two elements 16 and 20.

The reinforcement ring 20 and the sealing cover 16 may be made from materials suitable for permitting their reciprocal gluing or welding. For example, the reinforcement ring 20 may be made from a cellulose-based material, such as paper and/or from another rigid or semi-rigid material which may include at least one resin or gum. The sealing cover 16 may be made, for example, from a cellulose-based material such as paper.

In certain embodiments, the reinforcement ring 20 and the sealing cover 16 project radially beyond the annular portion 181, so as to present respective outer annular portions facing each other and reciprocally coupling. Alternatively, or in addition, the annular portion 181 may be traversed by slots or holes 181″ suitable for favouring the gluing or welding of the reinforcement ring 20 to the sealing cover 20.

Again with reference to the embodiment shown in FIG. 4, alternatively or in addition to welding or gluing, either the reinforcement ring or the cover 16 may be folded one onto the other so as to reciprocally couple and block the annular portion 181 between them.

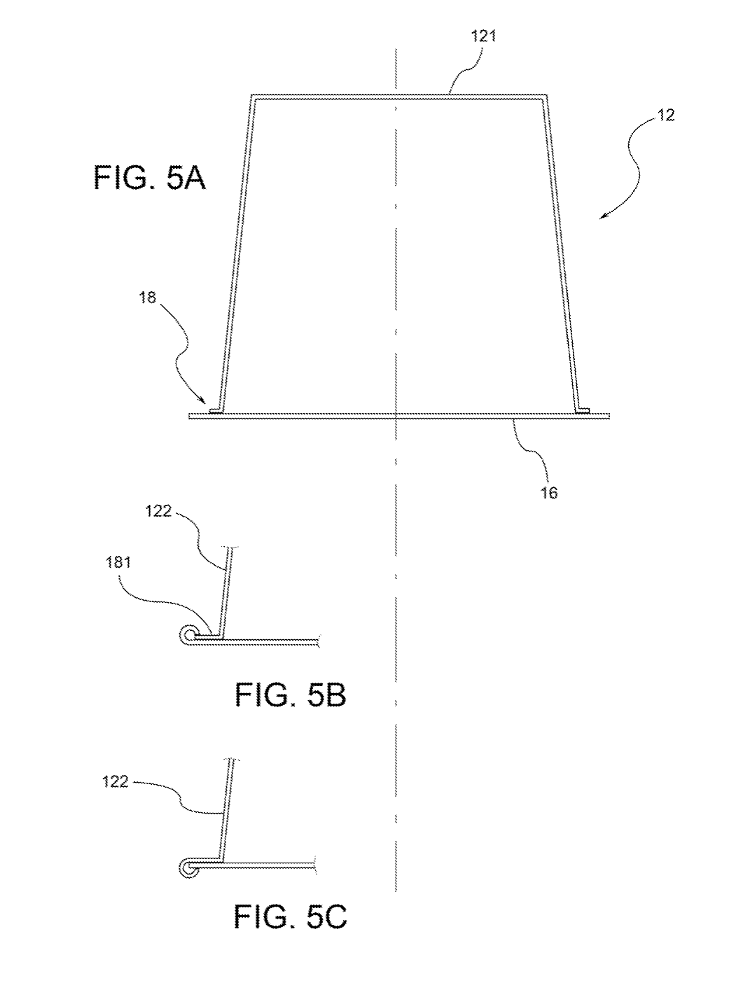

In certain embodiments such as that shown in FIG. 5A, the sealing cover 16 has a greater rigidity than the tray-like body, as a result of, for example, greater thickness or by the type of material or processing utilised, and extends radially beyond the rim of the open end 14 to form the peripheral annular rim 18.

Such sealing cover 16 may abut with and be attached to the annular portion 181 of a sheet of paper of the tray-like body. The attachment may be made, for example, by gluing, welding or by deformation of said cover 16 and/or of said annular portion 181, for example formed by a curled fold on one of the two so as to engage the other (FIGS. 5B and 5C).

In certain embodiments of the capsule, the film or sealing cover 16 hermetically seals the tray-like body. Such capsules are therefore suitable for use in an infusion group provided with perforations in the capsule.

In certain embodiments, the film or sealing cover 16 is made with a permeable or filter material or is provided with holes for the passage of the infusion liquid inside the tray-like body 12. In such cases the capsule may be used in infusion groups lacking perforations in the capsule.

In certain embodiments, the tray-like body 12 and the cover or sealing film 16 are coated with a film of plastic material, such as polyethylene or polyethylene terephtalate, ethylene vinyl alcohol (EVOH), suitable for acting as a barrier to the oxygen so as to prevent oxidation of the aromatic substance contained therein or the proliferation of bacteria in the case of, for example, fruit juices. The paper material which the tray-like body 12 is made of, the sealing film 16 and the protective film may, moreover, be made from a biodegradable material.

It should be noted that the use of a reinforcement ring 20, as well as ensuring the hermetic seal of the closed infusion group, makes it possible to obtain capsules with variable thickness of the peripheral annular rim 18, therefore making them suitable for being used with infusion groups having different strokes of the infusors in the closing step.

Such reinforcement ring 20 may be attached during the packaging or filling of the capsule, for example by the same machine performing filling, or at the moment of moulding the tray-like body, or at the moment of preparing the paper disc used to make the tray-like body, before moulding.

The reinforcement ring 20, in addition, facilitates the correct insertion and extraction of the paper capsule into and out of the infusion chamber. In fact, such ring provides the outer annular rim of the capsule the rigidity needed to interact with the insertion and extraction of the capsule. Stiffening the annular rim by the reinforcement ring is particularly advantageous in the extraction step, when the paper capsule is wet and an insufficiently rigid rim could stick to one of the two infusors and/or be damaged by the extraction action itself.

The tray-like body in the form of a truncated cone as opposed to the paper pods currently on the market, permits an improved interaction with the infusion group, especially in the step of extracting the drink, and a greater resistance to the forces associated with the pressing of the aromatic substance.

To further increase the rigidity of the tray-like body, a further reinforcement ring, for example, one made from one of the materials described above, may be positioned around the truncated cone or cylindrical lateral surface of the tray-like body.

### REPRESENTATIVE ENUMERATED EMBODIMENTS OF THE INVENTION

1. A capsule for making an infused drink, comprising a tray-like body having a substantially cylindrical or a truncated cone shape said tray-like body being formed by a sheet of paper or paper material and open at one end, wherein a cover or sealing film is applied to said open end of the tray-like body, said capsule further comprising a peripheral annular rim suitable for abutting with a support surface which surrounds an infusion chamber of an infusion group when the capsule is inserted in said chamber, wherein at least said peripheral annular rim has a greater rigidity than the tray-like body.
2. The capsule of embodiment 1, wherein said peripheral annular rim comprises at least one annular portion of the sheet of paper and is formed integrally with the tray-like body.
3. The capsule of embodiment 2, wherein said peripheral annular rim comprises at least one reinforcement ring attached to said annular portion of the sheet of paper.
4. The capsule of embodiment 3, wherein said reinforcement ring is attached to the front side of said annular portion of the sheet of paper.
5. The capsule of embodiment 3, wherein said reinforcement ring is attached to the rear side of said annular portion of the sheet of paper.
6. The capsule of embodiment 3, wherein said reinforcement ring is attached to the rear side of the annular portion of the sheet of paper and is attached to the sealing cover so that said annular portion of the sheet of paper is retained between the reinforcement ring and the sealing cover.
7. The capsule of embodiment 3, wherein the reinforcement ring and the sealing cover are glued or welded or reciprocally wedged.
8. The capsule of embodiment 3, wherein the reinforcement ring and the sealing cover project radially beyond the annular portion, so as to present respective outer annular portions facing each other and are reciprocally coupling.
9. The capsule of embodiment 7, wherein the annular portion is traversed by slots or holes to promote the gluing or welding of the reinforcement ring to the sealing cover.
10. The capsule of embodiment 1, wherein at least said peripheral annular rim is of a greater thickness than the thickness of the walls of said tray-like body.
11. The capsule of embodiment 10, wherein said greater thickness of the peripheral annular rim is obtained by folding said annular portion of the sheet of paper back on itself at least once.
12. The capsule of embodiment 2, wherein the cover or sealing film of the tray-like body is positioned between the annular portion of the sheet of paper and the reinforcement ring.
13. The capsule of embodiment 4, wherein said reinforcement ring is held to the annular portion of the sheet of paper by a curled fold of said annular portion.
14. The capsule of embodiment 4, wherein the reinforcement ring comprises material which comprises at least one resin or gum.
15. The capsule of embodiment 2, wherein said sealing cover is affixed to said annular portion of the sheet of paper by gluing, welding or by deformation of said cover and/or of said annular portion.
16. The capsule of embodiment 1, wherein said cover or sealing film comprises paper or paper material.
17. The capsule of embodiment 1, wherein the film or sealing cover hermetically seals the tray-like body.
18. The capsule of embodiment 1, wherein the film or sealing cover comprises permeable or filter material or is provided with holes for the passage of the infusion liquid inside the tray-like body.
19. The capsule of embodiment 1, wherein the tray-like body is formed entirely in one piece.
20. The capsule of embodiment 1, wherein the tray-like body and cover or sealing film are coated with a film of plastic material, such as polyethylene or polyethylene terephtalate, suitable for preventing oxidation of the aromatic substance contained inside it.

1. A capsule for making an infused drink, comprising a tray-like body having a substantially cylindrical or a truncated cone shape said tray-like body being formed by a sheet of paper or paper material and open at one end, wherein a cover or sealing film is applied to said open end of the tray-like body, said capsule further comprising a peripheral annular rim suitable for abutting with a support surface which surrounds an infusion chamber of an infusion group when the capsule is inserted in said chamber, wherein at least said peripheral annular rim has a greater rigidity than the tray-like body.

2. The capsule of claim 1, wherein said peripheral annular rim comprises at least one annular portion of the sheet of paper and is formed integrally with the tray-like body.

3. The capsule of claim 2, wherein said peripheral annular rim comprises at least one reinforcement ring attached to said annular portion of the sheet of paper.

4. The capsule of claim 3, wherein said reinforcement ring is attached to the front side of said annular portion of the sheet of paper.

5. The capsule of claim 3, wherein said reinforcement ring is attached to the rear side of said annular portion of the sheet of paper.

6. The capsule of claim 3, wherein said reinforcement ring is attached to the rear side of the annular portion of the sheet of paper and is attached to the sealing cover so that said annular portion of the sheet of paper is retained between the reinforcement ring and the sealing cover.

7. The capsule of claim 3, wherein the reinforcement ring and the sealing cover are glued or welded or reciprocally wedged.

8. The capsule of claim 3, wherein the reinforcement ring and the sealing cover project radially beyond the annular portion, so as to present respective outer annular portions facing each other and are reciprocally coupling.

9. The capsule of claim 7, wherein the annular portion is traversed by slots or holes to promote the gluing or welding of the reinforcement ring to the sealing cover.

10. The capsule of claim 1, wherein at least said peripheral annular rim is of a greater thickness than the thickness of the walls of said tray-like body.

11. The capsule of claim 10, wherein said greater thickness of the peripheral annular rim is obtained by folding said annular portion of the sheet of paper back on itself at least once.

12. The capsule of claim 2, wherein the cover or sealing film of the tray-like body is positioned between the annular portion of the sheet of paper and the reinforcement ring.

13. The capsule of claim 4, wherein said reinforcement ring is held to the annular portion of the sheet of paper by a curled fold of said annular portion.

14. The capsule of claim 4, wherein the reinforcement ring comprises material which comprises at least one resin or gum.

15. The capsule of claim 2, wherein said sealing cover is affixed to said annular portion of the sheet of paper by gluing, welding or by deformation of said cover and/or of said annular portion.

16. The capsule of claim 1, wherein said cover or sealing film comprises paper or paper material.

17. The capsule of claim 1, wherein the film or sealing cover hermetically seals the tray-like body.

18. The capsule of claim 1, wherein the film or sealing cover comprises permeable or filter material or is provided with holes for the passage of the infusion liquid inside the tray-like body.

19. The capsule of claim 1, wherein the tray-like body is formed entirely in one piece.

20. The capsule of claim 1, wherein the tray-like body and cover or sealing film are coated with a film of plastic material suitable for preventing oxidation of the aromatic substance contained inside it.
